(19) United States
(12) Patent Application Publication
(10) Pub. No.: US 2007/0150385 A1
(43) Pub. Date: Jun. 28, 2007

(54) ACCOUNTANT AUDIT/REVIEW CONSOLE

(76) Inventor: Frederick J. Ode, Strongsville, OH (US)

Correspondence Address: PROSKAUER ROSE LLP, 1001 PENNSYLVANIA AVE, N.W.,, SUITE 400 SOUTH, WASHINGTON, DC, 20004, US

(21) Appl. No.: 11/531,540

(22) Filed: Sep. 13, 2006

Related U.S. Application Data
(60) Provisional application No. 60/716,629, filed on Sep. 13, 2005.

(51) Int. Cl. G07F 19/00

(52) U.S. Cl. 705/30

(57) ABSTRACT

A system and method are disclosed to provide financial information in a report format for financial audits and/or reviews.

### CROSS REFERENCE TO RELATED APPLICATIONS

The present application claims the benefit of priority of U.S. Provisional Application Ser. No. 60/716,629 filed Sep. 13, 2005, which is hereby incorporated by reference in its entirety herein.

### TECHNICAL FIELD

Embodiments of the present invention relate to accounting software systems and more particularly to methods and systems for reviewing account data.

### BACKGROUND OF THE INVENTION

Sophisticated accounting software is used widely by small businesses. Typically, such accounting software is user-friendly, making it possible for business owners to use it in day-to-day business operations without the help of accounting specialists. However, periodic review of accounts by accounting specialists is typically required. Accounting specialists who perform such periodic reviews must work with many different software systems, each with its own characteristics including the report formats, report-generation controls, and other idiosyncrasies. The resulting variety can make the job of periodically accessing and reviewing reports tedious, error-prone, and expensive for the client. There is also a need in the art for specialized functions, such as data-access controls and report-types that provide for the peculiar requirements of such periodic reviews.

### BRIEF SUMMARY OF THE INVENTION

According to embodiments, the present invention provides user interface and report features which cater to the specific requirements of periodic review of financial accounts.

According to an embodiment, the invention is, in a computer, a method of providing financial accounting, comprising: accepting data representative of accounts payable, accounts receivables and generating at least a general ledger responsively thereto; generating audit controls for a user to enter commands to generate audit reports, the generating including identifying the controls as controls for generating audit report and generating audit reports responsively to user activation of the audit controls; generating non-audit controls for a user to enter commands to generate non-audit reports, the generating including identifying the controls as controls for generating non-audit report and generating non-audit reports responsively to user activation of the non-audit controls; the audit controls being generated in an audit display control specific to the auditing controls; the non-audit controls being generated in respective displays corresponding to non-audit functions including accounts payable and accounts receivable.

Preferably, the audit display control includes a graphical user interface window. Preferably, the audit controls include at least a control for invoking a gain/fade report. Preferably, the audit controls include criteria controls that specify criteria used to query a financial database. Also, preferably, the data entered in the criteria controls by a user are persisted over at least the duration of a user-session, the duration being defined between instances of user login and logoff operations. Also, preferably, the audit controls include controls to invoke an audit report, the invocation of an audit report resulting in the generation of additional controls for accepting data to be used to further specify a query to be run on the database. Also, preferably, the audit controls include criteria controls that specify criteria used to query a financial database, the method further comprising, receiving command data specifying a first query via the criteria controls and receiving a command to generate an audit report and, responsively to the receiving of a command to generate an audit report, generating a second-level criteria control to further narrow a second query derived from the first query. Also, preferably, the further comprising includes displaying a report on a computer display which is responsive to the second query.

These and other advantages and novel features of the present invention, as well as details of illustrated embodiments thereof, will be more fully understood from the following description and drawings.

### BRIEF DESCRIPTION OF DRAWINGS

FIG. 1 illustrates an exemplary embodiment of an accountant Audit/Review Console window displaying a window Reports screen, in accordance with various aspects of the present invention.

FIG. 2 illustrates an exemplary embodiment of the accountant Audit Console window of FIG. 1 displaying a window Adjustments screen, in accordance with various aspects of the present invention.

FIG. 3 illustrates an exemplary embodiment of the accountant Audit/Review Console window of FIG. 1 and FIG. 2 displaying further information, in accordance with various aspects of the present invention.

FIG. 4 illustrates an exemplary embodiment of a compare periods groupbox screen, displayed in accordance with various aspects of the present invention.

FIG. 5 illustrates an exemplary embodiment of a job progress schedule, displayed in accordance with various aspects of the present invention.

FIG. 6 illustrates an exemplary embodiment of a contract status report, displayed in accordance with various aspects of the present invention.

FIG. 7 illustrates an exemplary embodiment of a job billing backlog report, displayed in accordance with various aspects of the present invention.

FIG. 8 illustrates an exemplary embodiment of a cash flow by contract report, displayed in accordance with various aspects of the present invention.

FIG. 9 illustrates an exemplary embodiment of a job status and contact info list, displayed in accordance with various aspects of the present invention.

FIG. 10 illustrates an exemplary embodiment of a criteria tab for a Gain/Fade Analysis Report, displayed in accordance with various aspects of the present invention.

FIG. 11 illustrates an exemplary embodiment of a Gain/Fade Analysis Report, displayed in accordance with various aspects of the present invention;

FIG. 12 illustrates an exemplary embodiment of a system providing a accountant Audit/Review Console, in accordance with various aspects of the present invention.

FIG. 13 illustrates an exemplary alternative embodiment of a system providing a accountant Audit/Review Console, in accordance with various aspects of the present invention.

FIG. 14 is a figurative representation of user interface elements and a flow in a process of displaying the elements in sequence.

### DETAILED DESCRIPTION OF EMBODIMENTS

An Audit/Review Console is an interface that aggregates controls for generating auditing-type reports. Such reports are generally used by accountants to audit the accounting data to test its integrity and conformance to legal standards and customary accounting practices. The controls includes ones for report generation, filtering and sorting preferences, a user profile, and other controls peculiar to the auditing function.

In a preferred embodiment, the Console provides access to reports conforming to one or more accepted practice standard such as PPC's Guides to Accounting and Auditing. More preferably, the Console is provided in an accounting software system for construction contractors. In this context, in a preferred embodiment, the reports preferably conform to PPC's Guide to Construction Contractors.

Preferably the controls are designed as single-action controls, such as the stereotypic graphical user interface (GUI) controls typically identified as “buttons,” which can be selected and activated with a user interface pointer such as a mouse or tab key. Preferably, selection controls are provided to allow a user to select data, such as by applying filters or designing a query. Preferably, at some of such controls are provided on the same interface control (e.g., window) as the single action controls providing access to the reports. More preferably, the data entered in such selection controls is maintained or persisted through various other functions, for example, a date-selection criterion entered into the controls is automatically applied to any reports invoked via the single-action controls.

In preferred embodiments, the following selection controls are provided on the main report-selection control:
Transaction Date Range Start Date for an analysis interval (1 or more entries)
Transaction Date Range Start Date End Date for the analysis interval (1 or more entries)
Date Range Step indicating an optional interval (e.g., monthly) to generate multiple date intervals beginning at the Date Range Start Date
Job Identifier (1 or more entries)
Transaction Minimum Dollar Amount
Transaction Maximum Dollar Amount
Field to sort by & order (e.g., ascending or descending)
Classes such as Geographical, Organizational Units, Project type, Project Manager (1 or more entries)
Project status (e.g., active, inactive, closed, internal)
Show only records whose transaction and invoice dates do not match
Ordinal selection, for example, highlight every Nth record or a data subset thereof, where N is a user-entered value
Random selection, for example, highlight every RAND( )th record such that M % records are selected, where M is a user-selected value between 0 and 100. Note that any of the highlight criteria in the present list may be used as bias indicators such that records are selected based on the criteria, but the application of the filter is fuzzy based on the criteria.
Random selection, with bias, the bias being such that certain records meeting specified criteria are more likely to be selected than others, for example, more records in which a transaction and invoice data do not match would be selected than others.
Formatting preferences, such as page breaks between records, Verbose vs. Concise Job Identification.

In addition to certain of the above providing data record selection and display criteria to filter the data display set, the following are preferably used as criteria for highlighting information that is subsumed by the selection set. Highlighting is used for reviewing reports to focus attention on particular records to allow a quantifiable total that is reviewed (say, of 10% of all records) while still permitting the reviewer an opportunity to see other records than those particular ones selected specifically to be considered in the review total. So rather than excluding records other than the M % selected for review, all the records are shown but the M % are highlighted. In this way, for example, the reviewer can spot obvious irregularities outside the selection set even though his review of non-highlighted records/fields are not the principal focus of the review.
Transaction Date Range Start Date for an analysis interval (1 or more entries)
Transaction Date Range Start Date End Date for the analysis interval (1 or more entries)
Date Range Step indicating an optional interval (e.g., monthly) to generate multiple date intervals beginning at the Date Range Start Date.
   For this and all date input controls, the date information may be specified as the current day plus or minus an interval, the current month, the current quarter, or a relative time interval or relative date so that the selection can be established when first used by a reviewer and then, upon returning to review additional data after a period of time, the reviewer can simply populate all the selections from his previous review and they will be offset relative to the current date automatically. So, for example, if the reviewer wishes to review data from the last four months each quarter, such that he is reviewing one month from the prior quarter and all three months of the current quarter, he can simply allow the system to auto-select the current quarter or type in a current quarter override. Then any other date fields required to specify the interval can be populated from these inputs.
Ordinal selection, for example, highlight every Nth record or a data subset thereof
Random selection, for example, highlight every RNAD( )th record such that M % records are highlighted, where M is a user-selected value between 0 and 100. Note that any of the highlight criteria in the present list may be used as bias indicators such that records are highlighted based on the criteria, but the application of the filter is fuzzy based on the criteria.
Random selection, with bias, the bias being such that certain records meeting specified criteria are more likely to be selected than others, for example, more records in which a transaction and invoice date do not match would be highlighted than others.
Job Identifier (1 or more entries)
Transaction Minimum Dollar Amount
Transaction Maximum Dollar Amount
Classes such as Geographical, Organizational Units, Project type, Project Manager (1 or more entries)
Project status (e.g., active, inactive, closed, internal)

Any of these data which are left blank have no effect on the resulting reports. That is, if a job number is not provided, all jobs are included in the reports.

In a preferred embodiment for construction contractor systems, the invention provides controls for immediate access to the following basic set of reports.
Gain/Fade Reports: Provides information on the profit or loss (a.k.a. gain or fade) by construction job over one or more time intervals periods in order to give a snapshot of a contractor's bidding and billing processes.
Job and G/L Tie-Out: Provides a view of General Ledger transactions for selected jobs. This report requires an explicit correspondence between G/L data and a job identifier. According to an embodiment of the invention, a job index is attached to the G/L data permitting data to be filtered based on the job index.
Materiality Reports: For Accounts Payable, Accounts Receivables and General Ledger, Materiality reports show transaction of a minimum dollar amount traced from start to finish.
Billing Back Log Reports: Shows work remaining to be completed in a standard format used by Certified Public Accountants (CPAs).
Over/Under Billing Report: Computes over or under billing by job and displays source information for the report.
Cut-Off Reports: Shows, payable invoices, receivable invoices, checks and cash receipts. These reports show payments made or received outside the audit period for invoices inside the period.
Flexible Aging Reports with Materiality: Standard receivables aging reports preferably enhanced by the ability to include only transactions with a minimum dollar amount.
Multi-Period Trial Balance: A standard Trial Balance preferably provided for multiple periods (weeks, months, years, etc.).

In preferred embodiments, all reports can be exported to external software such as spreadsheet programs.

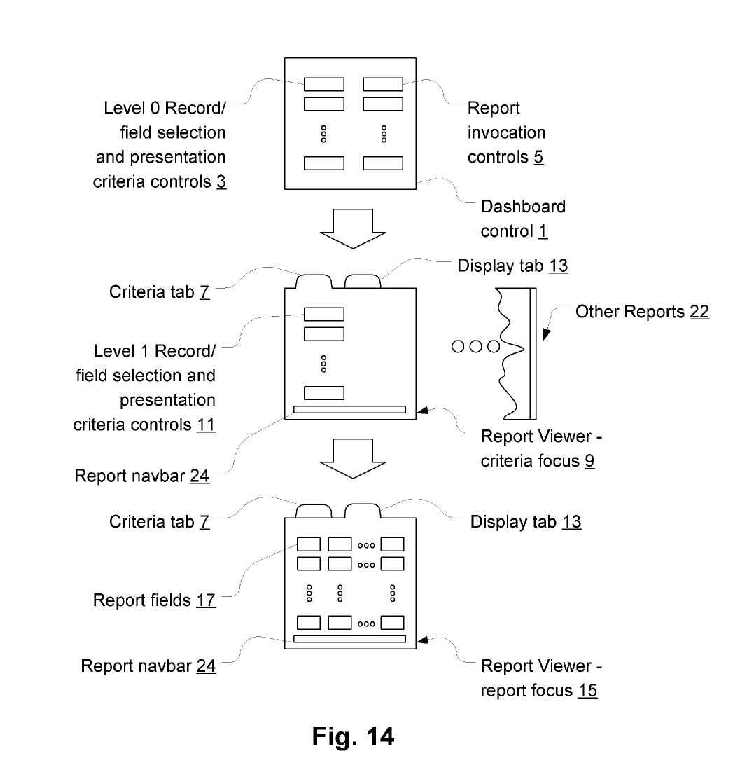

Referring to FIG. 14, preferably, the Audit/Review Console, represented in the drawing generically as a dashboard control 1, which may be a window, a dialog box, a text form, a web form, or any type of user interface control. The word “control” is used here generically to identify user interface elements including elements that only display information as well as ones that provide for user input and these need not be merely graphical or textual in that they could encompass auditory interface elements such as command-by-voice software interfaces. Although it is not limited to two, there are two principal kinds of controls provided by the dashboard control 1, namely, record/field selection and/or highlight controls 3 and report invocation controls 5. The level 0 record/field selection and/or highlight controls 3 include controls for limiting the selection query invoked and/or selecting records/fields for highlighting as discussed with regard to the bullet lists above. They are identified as “level 0” because they are a subset of the universe of selection/highlight controls which are applicable to more than one report. So the data entered in the level 0 record/field selection and/or highlight controls 3 is applied to any reports invoked using the report invocation controls 5.

Preferably, in addition, the selections entered din the level 0 record/field selection and/or highlight controls 3 are preferably maintained until changed, such that, in a particular session. Preferably, the level 0 record/field selection and/or highlight controls 3 can be saved in a user profile so that they do not have to be re-entered, as discussed above.

The report invocation controls 5 allow the user to invoke a report viewer 9, 15 which has a criteria tab 7 and a display tab 13. The criteria tab displays further selection/highlight controls which may, in terms of content, overlap with the subject matter described above and described by way of some examples. The level 1 criteria of the level 1 record/field selection and/or highlight controls 11 correspond to those controls that are peculiar to the particular report to which the current report view. The Report viewer has two focuses, one, the criteria focus 9, displays the criteria controls including the level 1 criteria of the level 1 record/field selection and/or highlight controls 11. The other view, invoked by selecting the corresponding tab, display tab 13, shows the report itself generated according to the 0 level and level 1 record/field selection and/or highlight controls. The level 1 record/field selection and/or highlight controls 11 can also be persisted and/or saved in a profile so that they maintain their data values for full sessions or can be saved and loaded automatically when the reviewer creates a new session. Preferably, the automatic loading of these data can be done in response to the reviewer's self-identification through an authentication login procedure, the search and return of the profile and loading and display of the data.

In a preferred embodiment, a navbar 24 may be included in various views to allow other reports to be invoked without returning to the level 0 record/field selection and/or highlight controls 3. Although not shown, the navbar 24 contains controls such as buttons or other selection controls and performs at least part of the functions of the report invocation controls 5.

The following is a screen-by-screen illustration according to a particular embodiment.

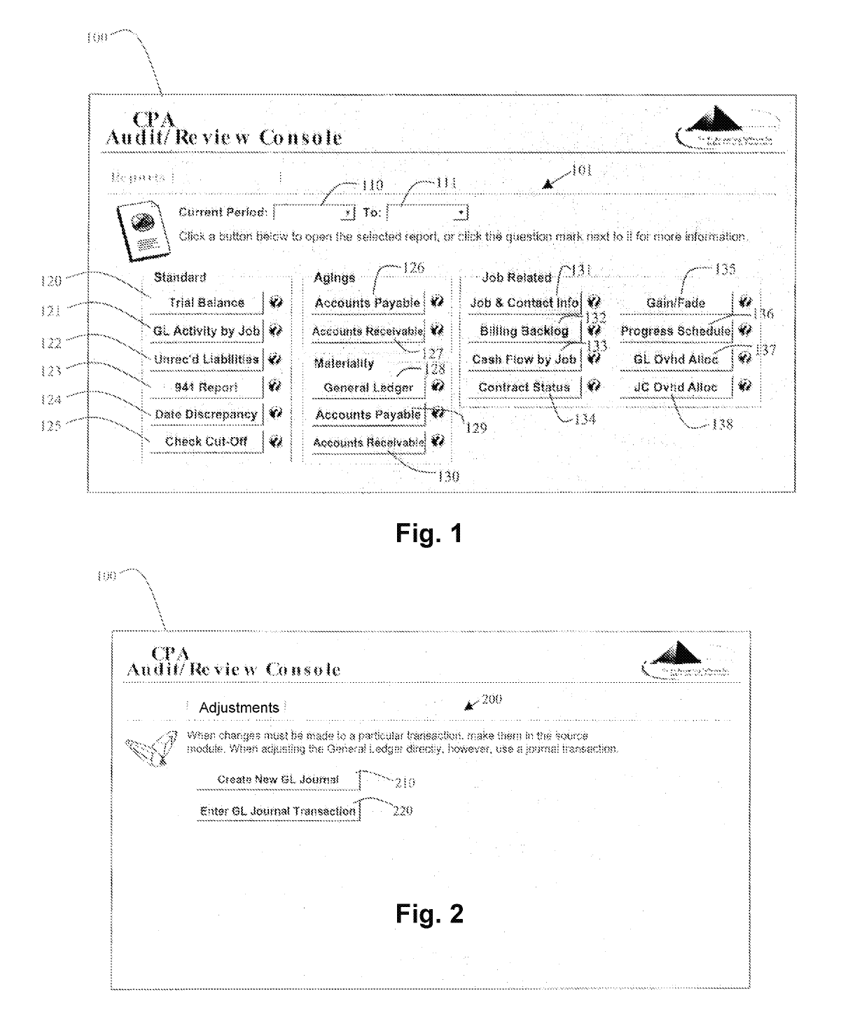

FIG. 1 illustrates an exemplary embodiment of a accountant Audit/Review Console window 100 displaying a window Reports screen 101, in accordance with various aspects of the present invention. In accordance with an embodiment of the present invention, the accountant Audit/Review Console is launched through a Tools menu and is displayed on a display of the computer-based platform. Notice that the word “Reports” at the top of the screen is in a darker text. The words “Adjustments” and “More” are in a lighter text and act as hyperlinks which can be selected using a mouse, for example.

In accordance with an embodiment of the present invention, the window Reports screen includes several fields and iconic buttons. The “Current Period” fields 110 and 111 are used to indicate the date range of the current fiscal period. The indicated dates are copied to corresponding fields on various report windows when launched.

The “Question Mark” iconic buttons (?) are used to launch help and additional information about the corresponding reports. These buttons are tied onto normal context-sensitive help and function as buttons on other response windows.

The “Trial Balance” iconic button 120, when clicked, launches a GIL Trial Balance Report window. The ending date of the “Current Period” fields is copied to the “As Of” field on the Trial Balance “Criteria Tab”. A Criteria Tab is used to encapsulate all of the desired criteria associated with a particular report or set of reports. Such Criteria Tabs may include, for example, “From/To” dates as well as job numbers.

The “G Activity by Job” iconic button 121, when clicked, launches a Job G Activity Report window. The indicated “Current Period” dates are copied to the “Date Range” and “To” fields on the Job G/L Activity “Criteria Tab.”

The “Unrec'd Liabilities” iconic button 122, when clicked, launches the A/P Invoice History Report window. The “Transaction Date From” field on the Invoice History “Criteria Tab” is set to the day after the “Current Period” end date, and the “Transaction Date To” field is set to 12/3112049”, for example.

The “941 Report” iconic button 123, when clicked, launches the Payroll 941 Deposit Report window. The indicated “Current Period” dates are copied to the “Date Range” and “To” fields on the 941 Deposit “Criteria Tab”. The “Format” field is set to “Report” and the “Include Third Party Sick Pay Adjustments” checkbox is enabled.

The “Date Discrepancy” iconic button 124, when clicked, causes a model dialog box to be displayed. The model dialog box includes two radio buttons (Accounts Payable and Accounts Receivable). In addition, the model dialog box includes and “OK” button and a “Cancel”0 button. When “OK” is clicked, the selected report is launched, as explained below herein. When “Cancel” is clicked, the dialog box is closed and the user is returned to the accountant Console window. When Accounts Payable is selected and “OK” is clicked, the A/P Full invoiceReport window is launched. The indicated “Current Period” dates are copied to the “Date Range” and, “To” fields on the Report “Criteria Tab”. The “Show Fully Paid Invoices” checkbox is enabled, and the new “Only invoices Using Different Trx and m Dates” checkbox is enabled. The “Format” field is set to “Detail”. When Accounts Receivable is selected and “OK” is clicked, the A/R Full invoice Report window is launched. The indicated “Current Period” dates are copied to the “Date Range” and “To” fields on the Report “Criteria Tab”. The “Show Fully Paid Invoices” checkbox is enabled, and the new “Only invoices Using Different Ta and Inv Dates” checkbox is enabled. The “Format” field is set to “Detail”.

The “Check Cut-Off” iconic button 125, when clicked, launches the G/L Check Register Report window. The indicated “Current Period” dates are copied to the “Transaction Date Range To” field on the Check Register “Criteria Tab”. The start date of the new “Book Date Range” and “To” fields are completed with the day after the “Current Period” ending date. The “Book Date To” field is set to 12/31/2049, for example. In addition, the Source: “A/P” and “P/R” checkboxes are enabled. However, the “AIR”, “E/Q”, and “J/C” checkboxes are disabled Also, the “Cash History Journal” checkbox is enabled.

The “Agings: Accounts Payable ” iconic button 126, when clicked, launches the Accounts Payable Aging Report window. The end date of the indicated “Current Period” is copied to the “Aging Date” field on the Aging “Criteria Tab”. The “Age Based On” field is set to “Invoice Date”. The cursor appears in the new “Minimum Dollar Amount” field

The “Agings: Accounts Receivable” iconic button 127, when clicked, launches the Accounts Receivable Aging Report window. The end date of the indicated “Current Period” is copied to the “Aging Date” field on the Aging “Criteria Tab”. The “Age Based On” field is set to “Trx Date”. The cursor appears in the new “Minimum Dollar Amount” field.

The “Materiality: General Ledger” iconic button 128, when clicked, launches the General Ledger History Detail Report window. The indicated “Current Period” dates are copied to the “Date Range” and “To” fields on the Detail Report “Criteria Tab”. The new “Minimum Dollar Amount” checkbox is enabled and the cursor appears in the new “Minimum Dollar Amount” field. The “Print Beginning Balance” and “Print Ending Balance” checkboxes are disabled.

The “Materiality: Accounts Payable” iconic button 129, when clicked, launches the report] window. The indicated “Current Period” dates are copied to the “Transaction Date From” and “To” fields on the History Report “Criteria Tab”. The new “Minimum Dollar Amount” checkbox is enabled and the cursor appears in the new “Minimum Dollar Amount” field. The “Totals Only” field is set to “No”.

The “Materiality: Accounts Receivable” iconic button 130, when clicked, launches the AIR Full invoice Report window. The indicated “Current Period” dates are copied to the “Date Range” and “To” fields on the invoice Report “Criteria Tab”. The new “Minimum Dollar Amount” check box is enabled and the cursor appears in the new “Minimum Dollar Amount” field. The “Format” field is set to “Detail” and the “Show Fully Paid” checkbox is enabled.

The “Job Related: Job & Contact Info” iconic button 131, when clicked, launches the Job List window. The “List Type” field is set to “Custom List” and the “Custom Design” field is set to “*Job Status List”. The “Job Status: Active and Closed” checkboxes are enabled, and the “Current Period” dates are copied to the new “Closed Date Range” and “To” fields on the List “Criteria Tab”.

The “Job Related: Billing Backlog” iconic button 132, when clicked, the J/C Activity Report window. The “Report” field is set to “Billing Backlog Report”. The indicated “Current Period” dates are copied to the “Date Range” and “To” fields on the J/C Activity “Criteria Tab”. Other criteria are set by the report design.

100441 The “Job Related; Cash Flow by Job” iconic button 133, when clicked, launches the J/C Activity Report window. The “Report” field is set to “*Cash Flow by Contract”.

The indicated “Current Period” dates are copied to the “Date Range” and “To” fields on the f/C Activity “Criteria Tab”. Other criteria are set by the report design.

The “Job Related: Contract Status” iconic button 134, when clicked, launches the TIC Activity Report window. The “Report” field is set to “Contract Status”. The indicated “Current Period” dates are copied to the “Date Range” and “To” fields on the TIC Activity “Criteria Tab”. Other criteria are set by the report design.

The “Job Related: Gain/Fade” iconic button 135, when clicked, launches the new Gain/Fade Report window. The ending date of the indicated “Current Period” is copied to the ending date of the “Period 4 From” and “To” fields.

The “Job Related: Progress Schedule” iconic button 136, when clicked, launches the J/C Activity Report window. The “Report” fields are set to “*Job Progress Schedule”. The indicated “Current Period” dates are copied to the “Date Range” and “To” fields as well as the “Closed Date Range” and “To” fields on the J/C Activity “Criteria Tab”. The “Job Status: Active and Closed” checkboxes are enabled, and the “Job Status: Inactive and Overhead” checkboxes are disabled. Other criteria is set by the report design.

The “Job Related: GIL Ovhd Alloc” iconic button 137, when clicked, launches the G/L Overhead Allocation Report window. The indicated “Current Period” dates are copied to the “Date Range” and “To” fields on Report “Criteria Tab”.

The “Job Related: f/C Ovhd Alloc” iconic button 138, clicked, launches the JIC Overhead Allocation Report window.

FIG. 2 illustrates an exemplary embodiment of th accountant Audit/Review Console window 100 displaying a window Adjustments screen 200, in accordance with various aspects of the present invention. The screen 200 is displayed when the user clicks “Adjustments” at the top of the Console window. Notice that the words “Reports” and “More!” are in slightly lighter text, while “Adjustments” is darker. The “Create New G/L Journal” iconic button 210, when clicked, launches the Journal window in Add Mode.

The “Enter GIL Journal Transaction” iconic button 220, when clicked, displays the Journal Selection dialog box.

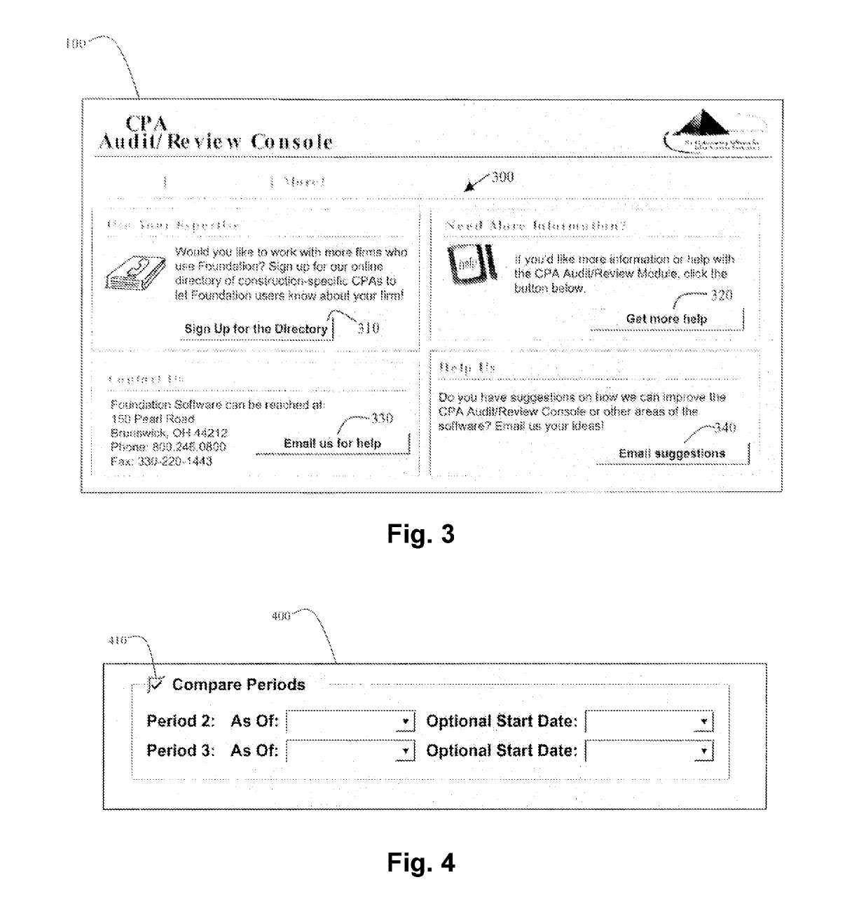

FIG. 3 illustrates an exemplary embodiment of the accountant Audit/Review Console window 100 displaying a window More! screen 300, in accordance with various aspects of the present invention. This screen 300 is displayed when the user clicks “More!” at the top of the Console window Notice that the words “Reports” and “Adjustments” are in slightly lighter text, while “More!” is darker.

The “Sign Up for the Directory” iconic button 310, when clicked, launches the system's default web browser which is pointed to a sign up URL address.

The “Get More Help” iconic button 320, when clicked, launches the accountant Module's Online Help system, using the default window, the main TOC, and to a default Help page.

The “Email us for help” iconic button 330, when clicked, launches the system's default email client with a new email addressed to, for example, support

The “Email suggestions” iconic button 340, when clicked, launches the system's default email client with a new email addressed to, for example, info@foundationsoft.com

In many instances, accountants would like to see comparative Trial Balances over several periods. While they could export the standard Trial Balance Report multiple times, this is cumbersome and can lead to errors when accounts have zero balances and the correct settings are not chosen.

To accommodate this, new fields are added to the Trial Balance “Criteria Tab” (or a “Criteria 2 Tab”). These fields allow the user to indicate the periods they wish to compare (see FIG. 4). When the “Compare Periods” checkbox is 410 checked, the fields of the groupbox 400 are enabled, and at least one of the “As Of” fields is completed by the user. On the report, the “As Of” date at the top of the report is removed. The current Debits and Credits columns are labeled (above the current labels) as “As Of <User-defined Main As Of Date>”, or if a main “Optional Start Date” is indicated, each labeled using the user-defined dates, for each period Where dates are indicated.

Accountants may use the G/L History Detail Report to analyze the materiality of transactions. Only transactions that meet or exceed a minimum dollar amount are included. There is a “Minimum Dollar Amount” checkbox and field located just above the “Description Type” field on the “Criteria 2 Tab”. The checkbox is unchecked by default and the field is protected. When the checkbox is checked, the amount field becomes unprotected and the default value is set to “0.00”. Included on the report only are transactions that, plus/minus any adjustments, are equal to or greater than the “Minimum Dollar Amount”. When an amount other than zero is entered in the field, the “Print Beginning Balance” and “Print Ending Balance” checkboxes on the “Criteria 1 Tab” are not enabled. In addition, no account or report subtotals are printed.

accountants may use the A/P Invoice History Report to analyze the materiality of transactions. Only transactions that meet or exceed a minimum dollar amount are included. There is a “Minimum Dollar Amount” checkbox and field just above the “Pay Class Type” field on the “Criteria Tab”. The checkbox is unchecked by default and the field is protected. When the checkbox is checked, the amount field becomes unprotected and the default value is set to “0.00”. Included on the report are only transactions that, plus/minus any adjustments, are equal to or greater than the “Minimum Dollar Amount”. When an amount other than zero is entered in the field, “Vendor Totals Only” is not allowed to be selected in the “Totals Only” field.

Accountants may use the A/R Full Invoice Report to analyze the materiality of transactions. Only transactions that meet or exceed a minimum dollar amount are included. There is a “Minimum Dollar Amount” checkbox and field to the right of the “Format” field on the “Criteria Tab”. The checkbox is unchecked by default and the field is protected. When the checkbox is checked, the amount field is unprotected and its default value is set to “0.00”. Included on the report are only transactions with a Total Invoice and/or Paid to Date that, plus/minus any adjustments, are equal to or greater than the “Minimum Dollar Amount”. When an amount other than zero has been entered in the field, “Summary” is not allowed to be selected in the “Format” field. This report may also be used to check date discrepancies which are those transactions that use a transaction date different than the invoice date. To accommodate this, there is a “Only Invoices Using Different Trx and Inv Dates” checkbox just below the “Show Full Address” checkbox. When this checkbox is enabled, “Summary” is not allowed to be selected in the “Format” field. Only invoices that meet other criteria and whose invoice date is not equal to the transaction date are included.

Accountants may use the A/R Aging Report to analyze the materiality of transactions. Only transactions that meet or exceed a minimum dollar amount are included. There is a “Minimum Dollar Amount” checkbox and field under the “Project Class Rang” fields on the “Criteria Tab”. The checkbox is unchecked by default and the field is protected. When the checkbox is checked, the amount field is unprotected and is set to a default of “0.00”. Only transactions that, plus/minus any adjustments, are equal to or greater than the minimum dollar amount are included on the report. When an amount other than zero has been entered in the field, the system does not allow “Summary” to be selected in the “Format” field, or “Running Balance” to be selected in the “Retainage” or “Running Balance” options buttons. Accountants may also desire to age invoices based on transaction date. The “Age Based On” field includes a “Trx Date” option. Invoices are aged using the “Trx Date” field on the Invoice Entry “General Tab”.

Accountants may use the A/P Aging Report to analyze the materiality of transactions. Only transactions that meet or exceed a minimum dollar amount are included. A “Minimum Dollar Amount” checkbox and field are located above the “Report Layout” groupbox on the “Criteria Tab”. The checkbox is unchecked by default and the field is protected. When the checkbox is checked, the amount field is unprotected and the default value is set to “0.00”. Only transactions that, plus/minus any adjustments, are equal to or greater than the minimum dollar amount are included on the report. When an amount other than zero is entered in the field, “Summary” and “Totals Only” are not allowed to be selected in the “Format” field. accountants may also desire to age invoices based on transaction date. The “Age Based On” field includes a “Trx Date” option. Invoices are aged using the “Ta Date” field on the Invoice Entry “General Tab”.

Accountants may want to research any checks that were cut after the year-end cut-off date. The Check Register Report includes the information desired to be seen, but the ability to filter based on the date booked (system date when the checks were posted) is needed. There are “Date Booked Range” and “To” fields just below the “Reconciled Date Range” fields. There is also a “Book Date” column to the right end of the report.

Accountants need to be able to run job costing reports for those jobs that are currently in progress and for any jobs that were closed during the current year. To accommodate this, the job status logic is expanded to include the date on which a job was closed. The “Job End Date” field on the Job “Addl Tab” may b used to indicate when a job was closed. The “Job Start Date” and “Job End Date” fields display the last digit of the year. The J/C Activity Report “Criteria Tab” includes “Closed Date Range” and “To” fields just below the “Job Status” checkboxes. These fields are enabled only when the “Closed” status checkbox is checked. If left blank, all jobs with a “Closed” status are included. If completed, only jobs with a “Job End Date” falling on or between the indicated dates are included.

As with the J/C Activity Report Criteria, “Closed Date Range” and “To” fields are included in the Job List “Criteria Tab” just below the “Show Job Status” fields and function in the same way as previously described.

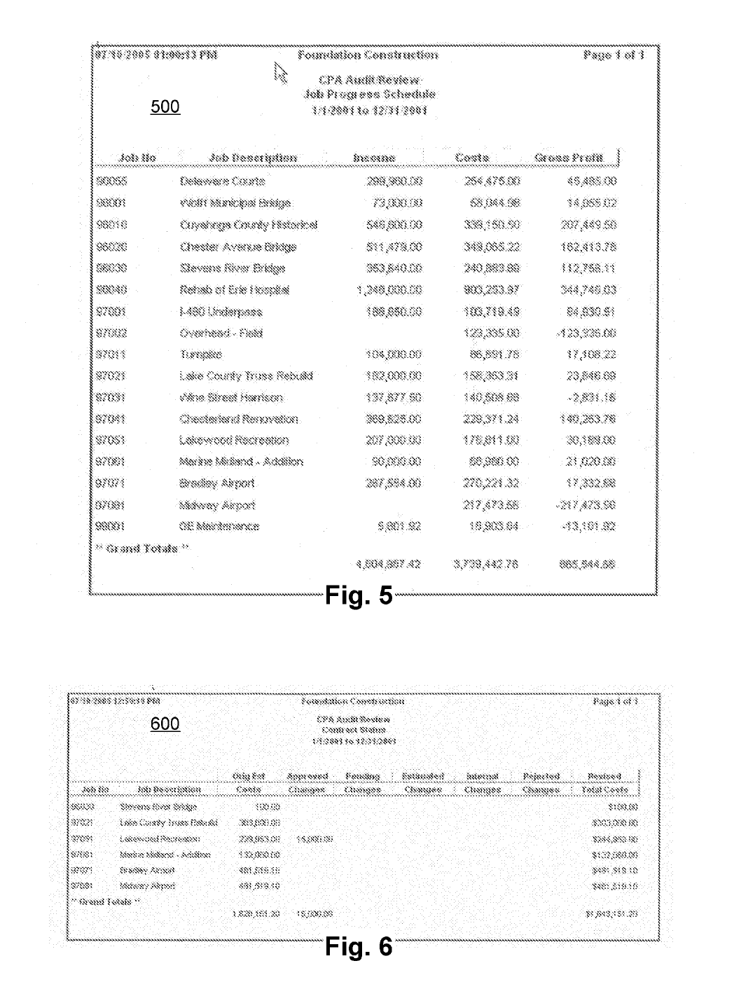

The Job Progress Schedule report is designed to show the job number, description, revenue, direct cost, and gross profit. accountants usually desire to run this first for all jobs in progress and, second, for all jobs completed during the current year. The “Closed Date Range” fields as previously described accommodate this second requirements. FIG. 5 illustrates an exemplary embodiment of a job progress schedule 500, displayed in accordance with various aspects of the present invention.

The Contract Status report provides a detailed breakdown of change orders to job budgets and includes the original contract amount and the amounts of change orders by status. FIG. 6 illustrates an exemplary embodiment of a contract status report 600, displayed in accordance with various aspects of the present invention.

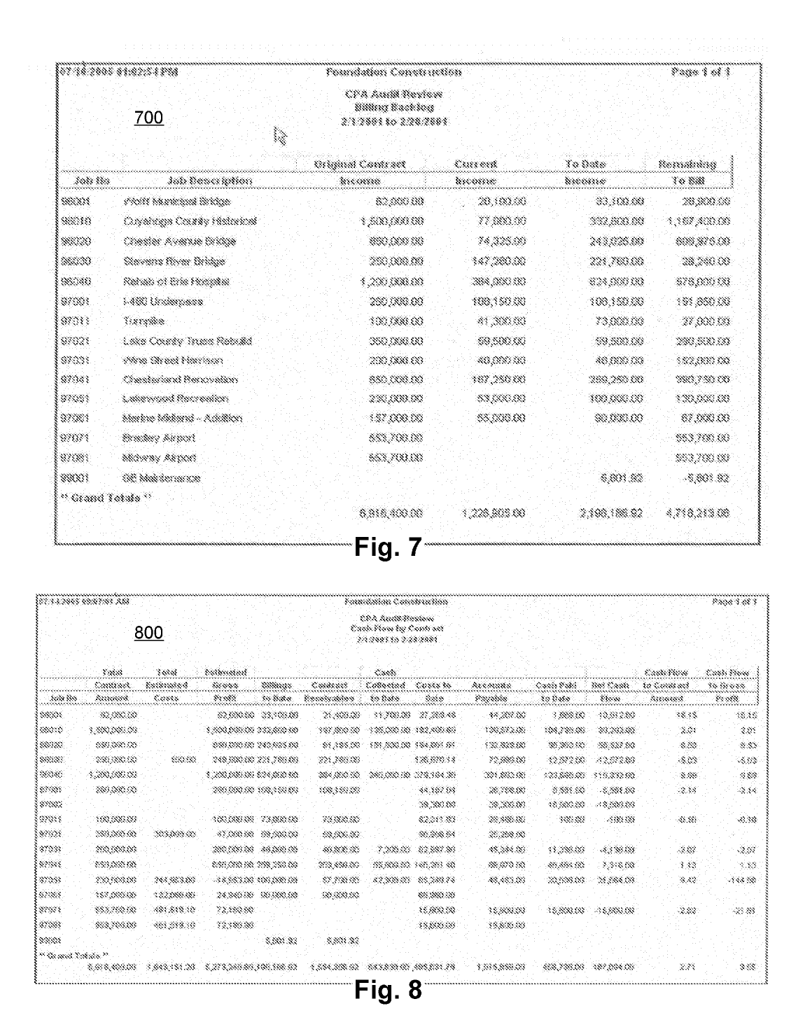

The purpose of the Billing Backlog report is to show work remaining to be completed in the format used by most accountants. This report lists job number, description, original contract, total billed, and remaining to be billed. FIG. 7 illustrates an exemplary embodiment of a job billing backlog report 700, displayed in accordance with various aspects of the present invention in accordance with an alternative embodiment of the present invention, the Billing Backlog report includes a Revised Contract income column after the Original Contract Income column which reflects only Approved and Estimate change orders. The Remaining to Bill calculation is then based on the Revised Contract Income.

The Cash Flow by Contract report shows details about billings and costs per job in a format used by most accountants. FIG. 8 illustrates an exemplary embodiment of a cash flow by contract report 800, displayed in accordance with various aspects of the present invention.

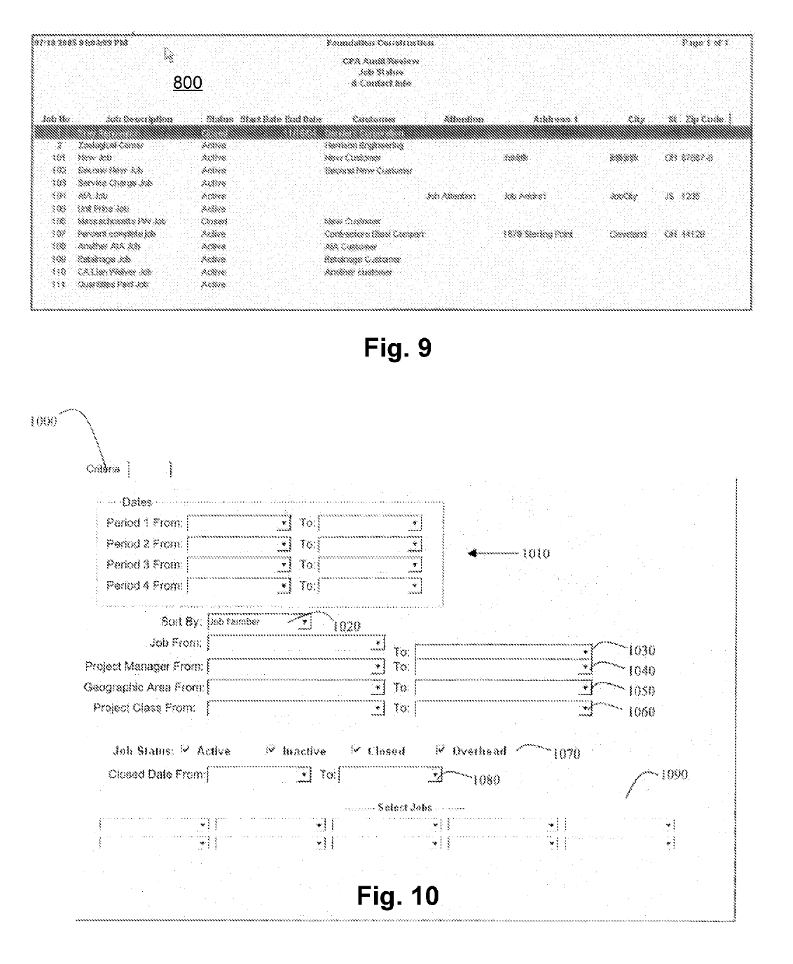

Accountants may desire to have some basic information regarding the current jobs and those jobs closed within the year. The Job Status List shows the status of jobs as well as some basic contact information. The addition of “Closed Date Range” fields, as previously described, accommodates reporting on jobs closed within the current year. FIG. 9 illustrates an exemplary embodiment of a job status and contact info list 900, displayed in accordance with various aspects of the present invention.

The A Full Invoice Report is launched at the “Date Discrepancy Report”. However, in the A/P, Reports menu, it is called the “Full Invoice Report”. This allows noon-accountant users to use it as a summary of invoice status, while accountant users can also run it to view any transactions that used a different transaction date than invoice date. This report is modeled after the A/R Full Invoice report. The Criteria Tab for the A/P Full Invoice report is very similar to the A/R Fill Invoice report, with the following exceptions:
“Customer Number Range” and “To” are instead “Vendor Number Range” and “To”;
100731 “Customer Name Range” and “To” and “To” are instead “Vendor Name Range” and “To”;
There are no “Job Number Range” and “To” fields;
The “Income Class Type” and “Pay Class” fields are replaced with the “A/P Pay Class” fields (as on the A/P Invoice History Report “Criteria Tab”);
The “Customer Types” checkboxes and groupbox are removed;

As with the A/R Full Invoice Report, a “Minimum Dollar Amount” checkbox and field are added, and “Only Invoices Using Different Trx and Inv Dates” checkbox is added. All other fields look and function the same (including the “Date Range” and “To” fields or “As of Date”, which are used to calculate the activity relevant to the dollar amounts included on the report). The report itself is very similar to the A/R version. It is grouped by vendor and reported one line per invoice. The “Total Invoice”, “Paid to Date”, “Balance Due”, and “Retainage” amounts include any activity/adjustments/reversals that fall within the indicated date range. The “Date Paid” column is changed to “Last Paid”, and shows the date of the most recent check within the indicated date range. The “Job No” column is removed. In “Summary” format, the “Customer No” and “Customer Name” are “Vendor No” and “Vendor Name”.

The Gain/Fade Analysis Report is similar to an over/under billing report but is provided in a format used by most accountants. FIG. 10 illustrates an exemplary embodiment of a criteria tab 1000 for the Gain/Fade Analysis Report, displayed in accordance with various aspects of the present invention. The “Dates” fields 1010 are used to indicate the date ranges for each of the four periods included on the report. The ending date of the last period is used as the “As Of Date” for the “To-Date” columns. The “Sort By” field 1020 is used to sort by job number or job name. The “Job From and To” fields 1030 are used to filter the jobs included in the report based on job number. The “Project Manager From and To” fields 1040 are used to filter the jobs included in the report based on project manager assigned to the job. The “Geographic Area From and To” fields 1050 are used to filter jobs included in the report based on geographic area assigned to the job. The “Project Class From and To” fields 1060 are used to filter the jobs included in the report based on project class assigned to the job. The “Job Status” checkboxes 1070 are used to filter the jobs included in the report based on their status. The “Closed Date From and To” fields 1080 are only enabled when the “Closed” status checkbox is checked. If blank, all jobs with a “Closed” status are included. If completed, only jobs with a “Job End Date” falling on or between the indicated dates are included. The “Select Jobs” fields 1090 are used to filter the jobs included in the report and works as other selected fields.

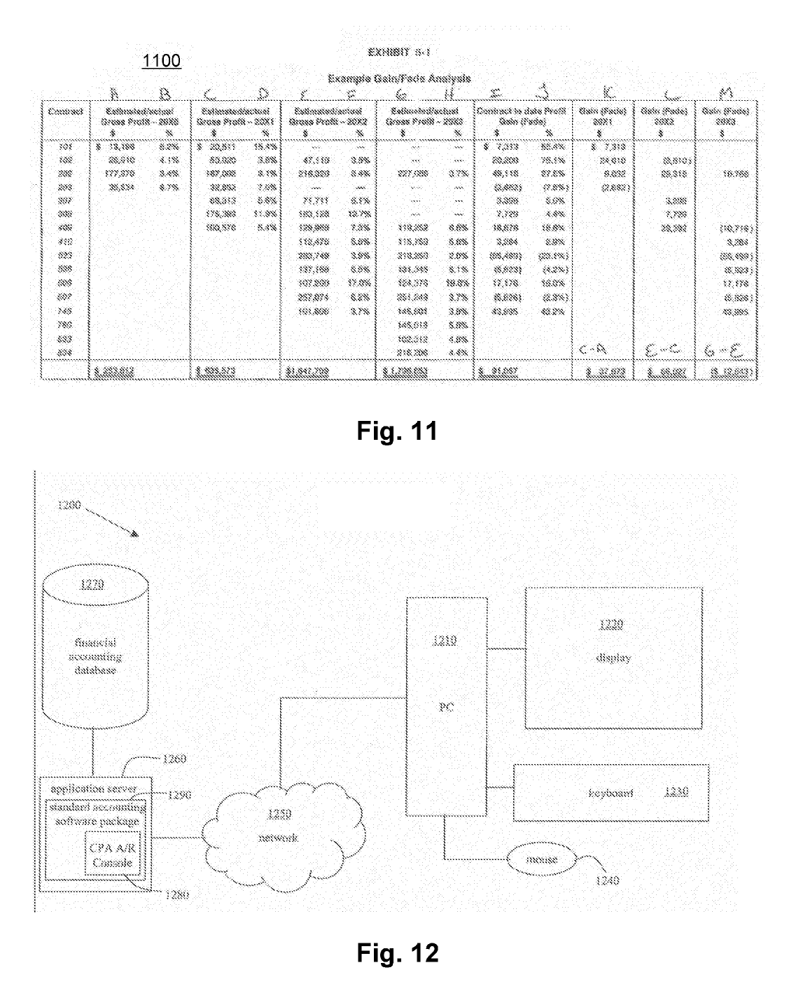

FIG. 11 illustrates an exemplary embodiment of a Gain/Fade Analysis Report 1100, displayed in accordance with various aspects of the present invention. The “Contract” column includes the job number and description for all jobs with any activity in the indicated date range. Column “A” shows the profit (costs−income) for the job for the indicated date range. Column “B” is calculated as the Gross Profit for the period divided by the total income for the period. Column “C” shows the profit (cost−income) for the job for the indicated date range. Column “D” is calculated as the Gross Profit for the period divided by total income for the period. Column “E” shows the profit (cost−income) for the job for the indicated date range. Column “F” is calculated as the Gross Profit for the period divided by total income for the period. Column “G” shows the profit (cost−income) for the job for the indicated date range. Column “H” is calculated as the Gross Profit for the period divided by total income for the period. Column “I” shows the profit (costs−income) using the ending date of the Period 4 as the “As Of Date”. Column “J” is calculated as the Profit using the ending date of the Period 4 as the “As Of Date” divided by total income through the ending date of the Period 4. Column “K” represents the Gain/Fade between Periods 1 and 2 (i.e., Column “C”-column “A”). Column “L” represents the Gain/Fade between Periods 2 and 3 (i.e., column “E”-column “C”). Column “M” represents the Gain/Fade between Periods 3 and 4 (i.e., column “G”-column “E”).

In accordance with an embodiment of the present invention, the accountant Audit/Review Console is an integrated part of a standard accounting software package operating on a computer-based platform such as, for example, a personal computer (PC), a workstation, or a networked database system, and creates reports that may be used for the financial audit/review process.

In accordance with an alternative embodiment of the present invention, the accountant Audit/Review Console is a software module operating on a computer-based platform such as, for example, a personal computer (PC), a workstation, or a networked database system. The accountant Audit/Review Console interfaces with a standard accounting software package to extract information from the standard accounting software package and to create specialized reports that may be used for the financial audit/review process.

FIG. 12 illustrates an exemplary embodiment of a system 1200 providing a accountant Audit/Review Console 1280, in accordance with various aspects of the present invention. The system 1200 is a computer-based platform comprising a personal computer (PC) 1210, a display 1220, a keyboard 1230, a mouse 1240, a network 1250, an application server 1260, and a financial accounting database 1270.

The display 1220, the keyboard 1230, and the mouse 1240 operationally interface to the PC 1210. The PC 1210 operationally interfaces to the application server 1260 via the network 1250. The application server 1260 operationally interfaces to the financial accounting database 1270.

In accordance with an embodiment of the present invention, the accountant Audit/Review Console 1280 is a software module which is an integral part of a standard accounting software package 1290 which resides on the application server 1260 and uses the database 1270 to store financial accounting information and related information in an organized manner. A user (e.g., a accountant) accesses the standard accounting software package 1290 on the server 1260 via the network 1250 using the PC 1210, display 1220, keyboard 1230, and/or mouse 1240. Once the user accesses the standard accounting software package 1290, he may access the accountant Audit/Review Console 1280 through a menu or iconic display selections.

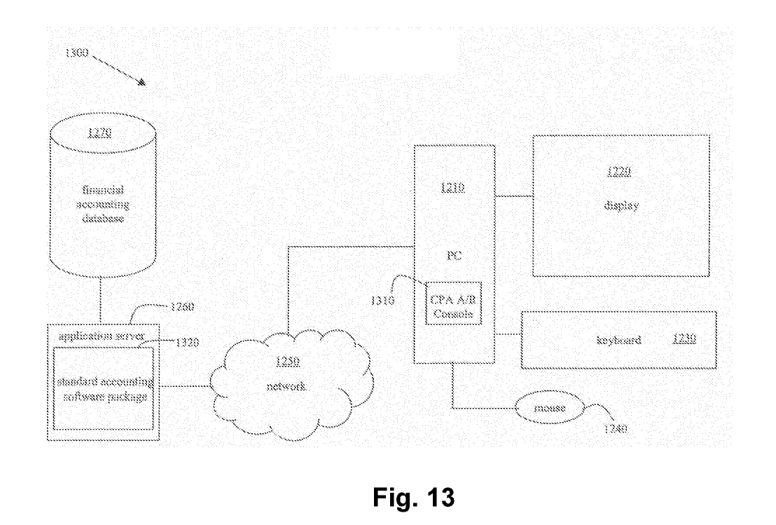

FIG. 13 illustrates an exemplary alternative embodiment of a system 1300 providing a accountant Audit/Review Console 1310, in accordance with various aspects of the present invention. In FIG. 13, the accountant Audit/Review Console 1310 is a software module residing on the PC 1210. A standard accounting software package 1320 resides on the application server 1260 and uses the database 1270 to store financial accounting information and related information in an organized manner. A user (e.g., a accountant) uses the PC 1210 (along with the display 1220, keyboard 1230 and/or mouse 1240) to access and launch the accountant Audit/Review Console 1310 on the PC 1210). The accountant Audit/Review Console 1310 communicates with the standard accounting software package 1320 on the server 1260 via the network 1250 such that the accountant Audit/Review Console 1310 is able to extract all of the needed information from the standard accounting software package 1320 in order to create the desired reports, lists, and transaction screens as previously described herein.

In accordance with various embodiments of the present invention, the network 1250 may include a local area network (LAN), a wide area network (WAN), or the Internet, for example. Other system configurations using a standard accounting software package and the accountant Audit/Review Console are possible as well, in accordance with various other embodiments of the present invention. For example, the standard accounting software package with an integrated accountant Audit/Review Console may reside on the PC 1210.

While the invention has been described with reference to certain embodiments, it will be understood by those skilled in the art that various changes may be made and equivalents may be substituted without departing from the scope of the invention, in addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. In a computer, a method of providing financial accounting, comprising:
accepting data representative of accounts payable, accounts receivables and generating at least a general ledger responsively thereto;
generating audit controls for a user to enter commands to generate audit reports, the generating including identifying the controls as controls for generating audit report and generating audit reports responsively to user activation of the audit controls;
generating non-audit controls for a user to enter commands to generate non-audit reports, the generating including identifying the controls as controls for generating non-audit report and generating non-audit reports responsively to user activation of the non-audit controls;
the audit controls being generated in an audit display control specific to the auditing controls;
the non-audit controls being generated in respective displays corresponding to non-audit functions including accounts payable and accounts receivable.

2. The method of claim 1, wherein the audit display control includes a graphical user interface window.

3. The method of claim 1, wherein the audit controls include at least a control for invoking a gain/fade report.

4. The method of claim 1, wherein the audit controls include criteria controls that specify criteria used to query a financial database.

5. The method of claim 4, wherein the data entered in the criteria controls by a user are persisted over at least the duration of a user-session, the duration being defined between instances of user login and logoff operations.

6. The method of claim 1, wherein the audit controls include controls to invoke an audit report, the invocation of an audit report resulting in the generation of additional controls for accepting data to be used to further specify a query to be run on the database.

7. The method of claim 1, wherein the audit controls include criteria controls that specify criteria used to query a financial database, the method further comprising, receiving command data specifying a first query via the criteria controls and receiving a command to generate an audit report and, responsively to the receiving of a command to generate an audit report, generating a second-level criteria control to further narrow a second query derived from the first query.

8. The method of claim 7, further comprising displaying a report on a computer display which is responsive to the second query.

9. A computer-readable medium storing a program embodying the methods of any of claims 1 through 8.
